(19) United States
(12) Patent Application Publication
(10) Pub. No.: US 2009/0289180 A1
(43) Pub. Date: Nov. 26, 2009

(54) Method and optical device for trapping a particle

(76) Inventors: Ilaria Cristiani, Pavia (IT); Carlo Liberale, Casteggio (IT); Paolo Minzioni, Pavia (IT)

Correspondence Address: Carmen Patti Law Group , LLC, ONE N. LASALLE STREET, 44TH FLOOR, CHICAGO, IL, 60602, US

(21) Appl. No.: 12/309,248

(22) PCT Filed: Jul. 5, 2007
(86) PCT No.: PCT/EP2007/056798

§ 371 Date: Jun. 30, 2009

(30) Foreign Application Priority Data
Jul. 12, 2006 (IT) MI2006A 001351

(51) Int. Cl. H05H 3/00

(52) U.S. Cl. 250/251

(57) ABSTRACT

It is disclosed an optical device for trapping a particle immersed in a fluid. The device of the invention comprises a light source and a probe for guiding and outputting the radiation received from the source. According to the invention, the guided radiation has an intensity distribution having intensity maximum placed at a non-zero distance from the probe longitudinal axis and having rotational symmetry about the longitudinal axis. Further, according to the invention, the intensity maximum is reflected at the interface between probe and fluid, and then it is output by the probe so that it creates a stable equilibrium point wherein the particle is trapped.

The present invention relates to an optical device and a method for trapping a particle, in particular a microscopic particle.

In the following description and in the claims, the term “microscopic particle” (or simply “particle”) will designate a portion of a material, such as e.g. an atom or an ensemble of aggregated atoms, a molecule or an ensemble of aggregated molecules, a cell or an ensemble of aggregated cells, or a cell organelle (such as for instance a mitochondrion), having a maximum size lower than 200 μm.

In the art, optical devices are known allowing to trap a microscopic particle which is in suspension within a fluid (such as for instance air, water, physiological solution or the like), and to block it in a desired position.

Such optical devices are based on a known physical effect which is termed “radiation pressure”. In particular, as explained by A. Ashkin in the paper titled “Optical trapping and manipulation of neutral particles using lasers”, Proc. Natl. Acad. Sci. USA, vol. 94, pages 4853-4860, May 1997, a radiation incident onto a particle applies to the particle two types of forces giving raise to the radiation pressure: the scattering force and the gradient force. The scattering force is directed substantially along the radiation propagation direction, and therefore it pushes the particle towards the radiation propagation direction. On the other hand, the gradient force is directed so as to push the particle towards zones with higher radiation intensity. For instance, if the radiation is a gaussian beam with plane wavefront, the scattering force is directed perpendicular to the beam propagation direction, and it pushes the particle towards the beam centre.

If the radiation is focused through an optical element with converging power, when the radiation impacts onto the particle, it still applies to the particle both the scattering force and the gradient force.

It is known that the converging power of an optical element is expressed by means of a parameter which is termed numerical aperture. The numerical aperture corresponds to the maximum angle at which an optical element is capable of receiving or transmitting light, and it depends on various geometrical parameters through formulas which vary according to the optical element type.

As it is known, the higher the numerical aperture, the higher is the inclination of the emitted ray relative to the radiation propagation direction. In other words, the distance between the optical element with converging power and the radiation convergence point decreases, i.e. the radiation is focused at a lower distance from the optical element.

Further, the higher the numerical aperture, the higher is the maximum intensity that the radiation reaches at the convergence point.

When the radiation is focused in a point, the scattering force and the gradient force may create a stable equilibrium point, which is placed close to the convergence point. In other words, the radiation pressure applies to the particle a restoring force, which draws the particle in the stable equilibrium point. Therefore, the radiation creates at the stable equilibrium point an “optical trap” in which the particle is trapped. By increasing the numerical aperture of the optical element focusing the radiation, the stability of the optical trap increases, i.e. the intensity of the restoring force that the radiation pressure applies to the particle increases.

U.S. Pat. No. 4,893,886 discloses a method of trapping biological particles by using an infrared laser. In particular, a light beam of the infrared laser impinges on a combination of optical elements which focus it with sufficient convergence to form an optical trap based on the gradient force to confine a biological particle in a desired position. The optical elements comprise a high numerical aperture lens objective, having a numerical aperture equal to about 1.25. The particle is observed through the same lens objective creating the optical trap.

The Applicant has noticed that this solution exhibits some drawbacks. First of all, since the particle is observed through the same lens objective used for focusing radiation, which has a high numerical aperture, the view field is very narrow, and the focal point is very close to the lens objective. Therefore, the solution of U.S. Pat. No. 4,893,886 only allows to trap and observe particles which are placed close to the free surface of the fluid. Further, the device of U.S. Pat. No. 4,893,886 is very complex and costly to manufacture, and it is very bulky.

JP9043434 discloses an optical tweezer wherein light emitted from a light source is guided by an optical fiber through an optical connector, and then it is emitted toward the object to be trapped. The exiting end part of the fiber is convergent, so that a force in a beam waist position direction is applied on the object.

The Applicant has noticed that also this solution exhibits some drawbacks. First of all, in the solution of JP9043434 the numerical aperture mainly depends on the difference between the refractive index of the optical fiber and the refractive index of the fluid in which the particle is immersed. In JP9043434 such a difference is small, and therefore the maximum numerical aperture which can be obtained is lower than the numerical aperture required for creating a sufficiently strong optical trap. Moreover, disadvantageously, the scattering force is not negligible. Therefore, the particle is not blocked in the optical trap, but it moves along the radiation propagation direction.

Accordingly, an object of the present invention is providing an optical device and a method for trapping a particle, in particular a microscopic particle, which overcomes the aforesaid drawbacks.

In particular, an object of the present invention is providing an optical device and a method for trapping a particle based on the gradient force, wherein the particle is substantially blocked in the optical trap and wherein the scattering force is substantially negligible, independently of the position of the particle relative to the fluid free surface.

These and other objects are achieved by an optical device according to claim 1 and a method according to claim 14.

According to a first aspect, the present invention provides an optical device for trapping a particle immersed in a fluid, comprising a light source and a probe having a first end, a second end and a longitudinal axis. The probe is configured to receive a radiation from the light source at the first end and to emit the radiation through the second end. The optical device is characterized in that, at the second end, the radiation has an optical intensity distribution with intensity maximum placed at a non-zero distance from the longitudinal axis of the probe and with a rotational symmetry about the longitudinal axis. Further, the optical device is characterized in that the second end is configured so that, at the intensity maximum, the radiation is reflected at the interface between the second end and the fluid, and the reflected radiation is output from the second end so that it converge in a convergence point, thus creating a stable equilibrium point wherein the particle is trapped.

Preferably, at least at the intensity maximum, the second end has a tapered shape with rotational symmetry about the longitudinal axis and having a given tapering angle. Preferably, the tapering angle is higher than or equal to a critical angle of the interface between the second end and the fluid. More preferably, the tapering angle is higher than or equal to 45°.

Optionally, the probe comprises at least two optical fibres, each comprising a respective core, such optical fiber being configured to have equal optical and geometrical characteristics. Such optical fibres, at the second end of the probe, are arranged parallel to the longitudinal axis with a rotational symmetry about the longitudinal axis. Preferably, each optical fibre, at the second end of the probe, is cut at least in the region of its core according to a plane forming with a plane perpendicular to the longitudinal axis of the probe an angle equal to the tapering angle.

Preferably, the probe comprises a central element having a longitudinal axis substantially coinciding with the longitudinal axis of the probe. The central element may comprise a reinforcing element comprising dielectric material, or an optical fiber.

Optionally, the probe comprises an optical fiber having at least two cores configured to have equal optical and geometrical characteristics. The two cores, at the second end of the probe, are arranged parallel to the longitudinal axis of the probe with a rotational symmetry about the longitudinal axis of the probe.

Optionally, the probe comprises an optical fiber having an annular core having substantially constant optical and geometrical characteristics along the perimeter of the annular core.

Preferably, the tapered shape is a conical frustum, or a straight pyramid having a regular polygon as a base.

According to a second aspect, the present invention provides a method for trapping a particle immersed in a fluid, comprising the following steps: emitting a radiation through a laser source, guiding the radiation from a first end to a second end of a probe, and outputting the radiation through the second end. The method is characterised in that, at the second end of the probe, the radiation has an optical intensity distribution with intensity maximum placed at a non-zero distance from a longitudinal axis of the probe and having a substantially rotational symmetry about the longitudinal axis of the probe. Further, the method is characterised in that, at the second end and at the intensity maximum, the radiation is reflected at the interface between the second end and the fluid, and it is output by the second end so that it converges in a focal point, thus creating a stable equilibrium point wherein the particle is trapped. Preferably, the radiation is reflected at the interface between the second end and the fluid so that the radiation undergoes a total reflection.

Optionally, the optical intensity distribution comprises at least two intensity maxima placed at a non-zero distance from a longitudinal axis of the probe and placed according to a substantially rotational symmetry about the longitudinal axis of the probe. Optionally, the optical intensity distribution comprises at least an annular intensity maximum.

The present invention will become clearer by reading the following detailed description, give by way of example and not of limitation, to be read with reference to the accompanying drawings wherein:

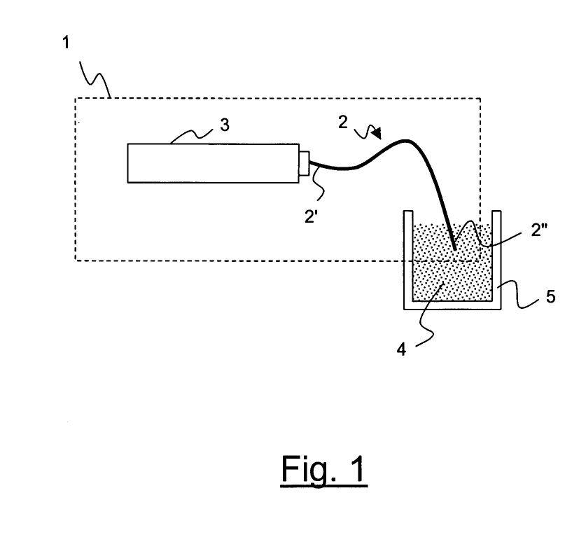

FIG. 1 schematically shows an optical device for trapping a particle;

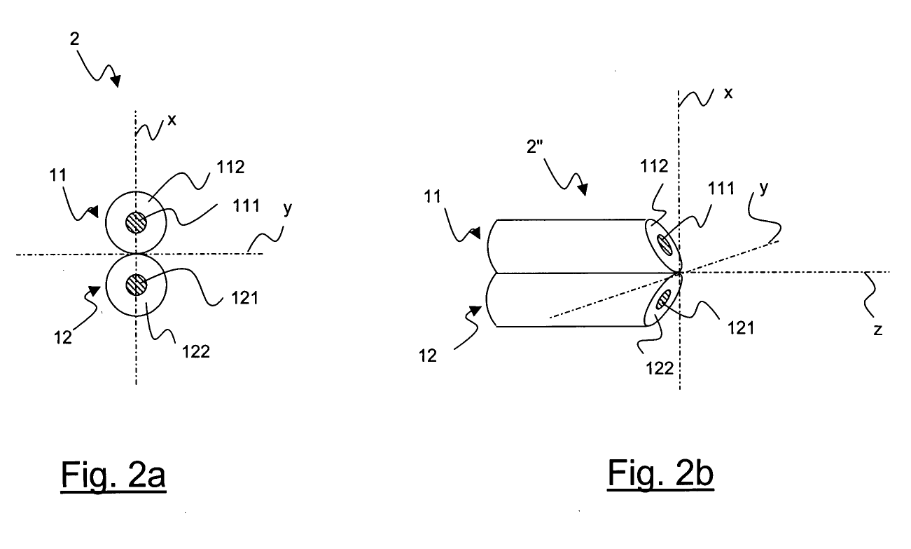

FIGS. 2a and 2b show a probe of the optical device according to a first embodiment of the present invention, in cross section and in perspective, respectively;

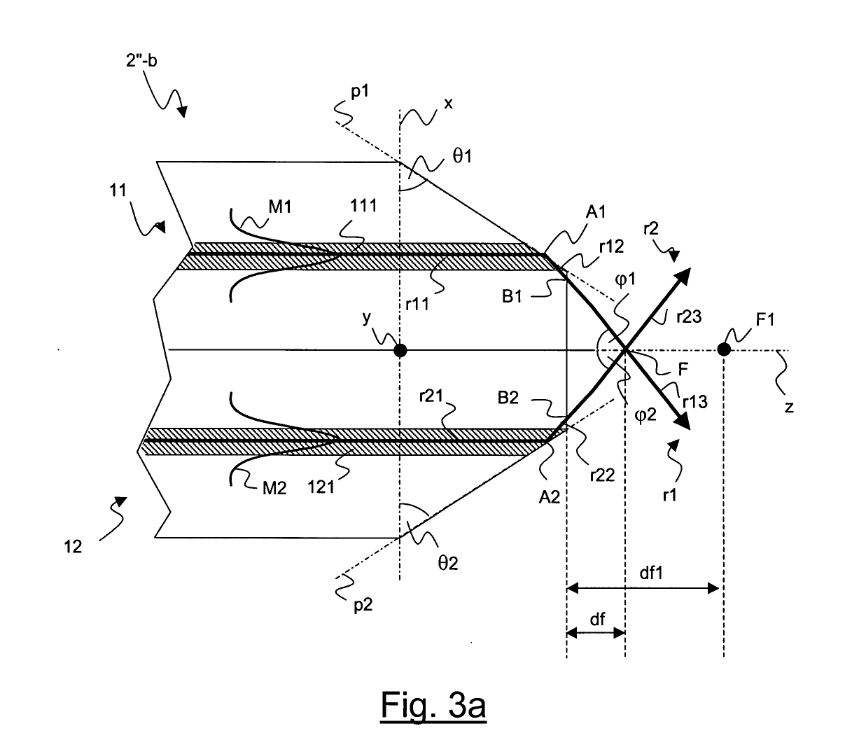

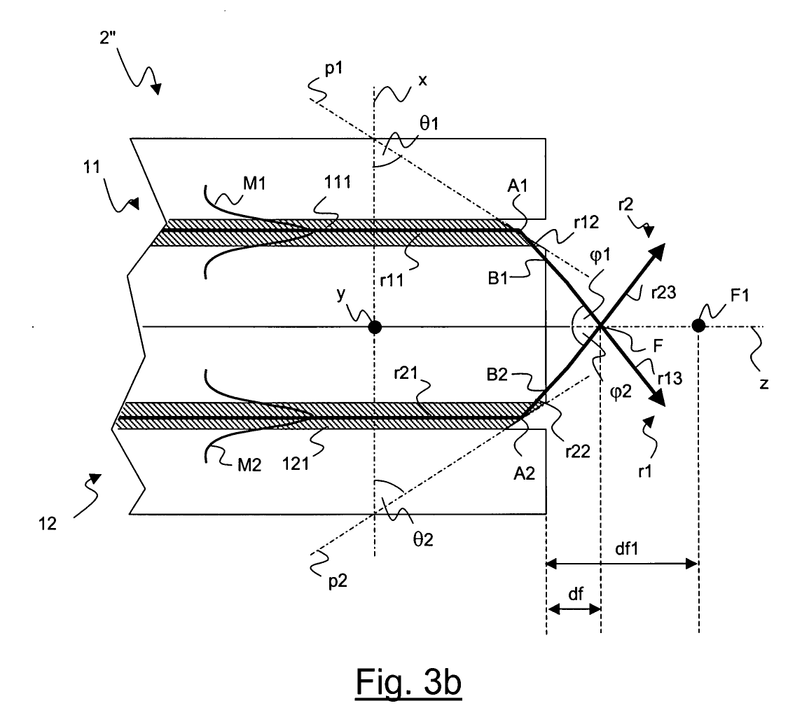

FIG. 3a shows a longitudinal sectional view of the probes of FIGS. 2a and 2b;

FIG. 3b shows a longitudinal sectional view of a variant of the probe shown in FIGS. 2a, 2b and 3a;

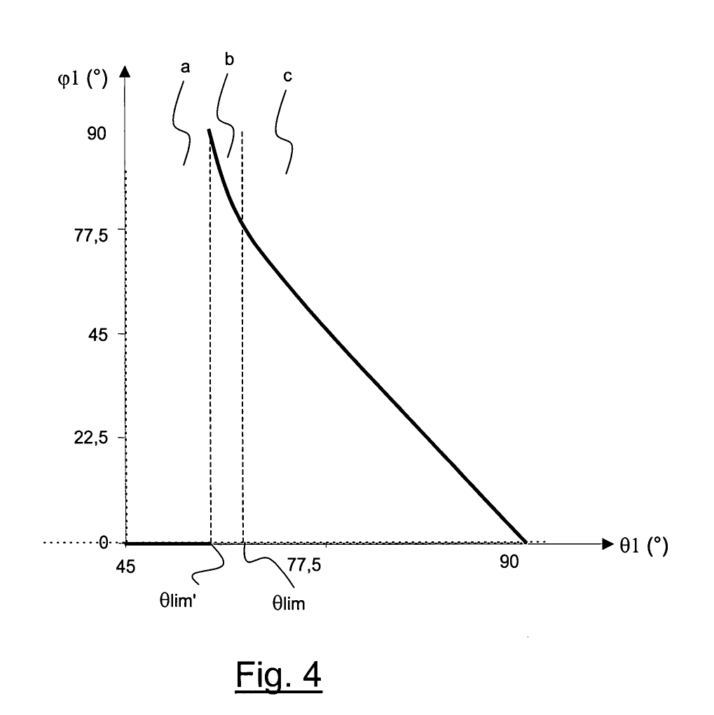

FIG. 4 shows a graph of the convergence angle of the probe of FIG. 3a versus the tapering angle;

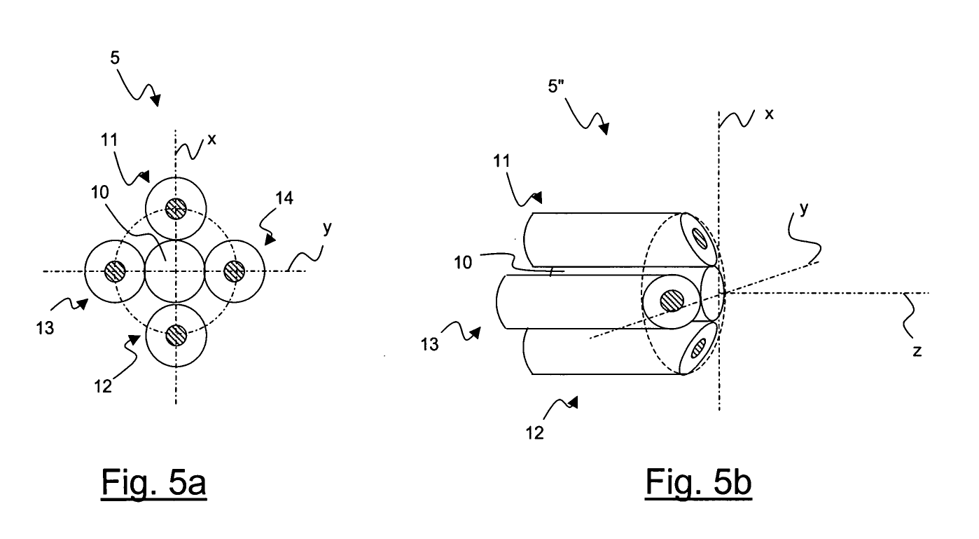

FIGS. 5a and 5b show a probe of the optical device according to a second embodiment of the present invention, in cross section and in perspective, respectively;

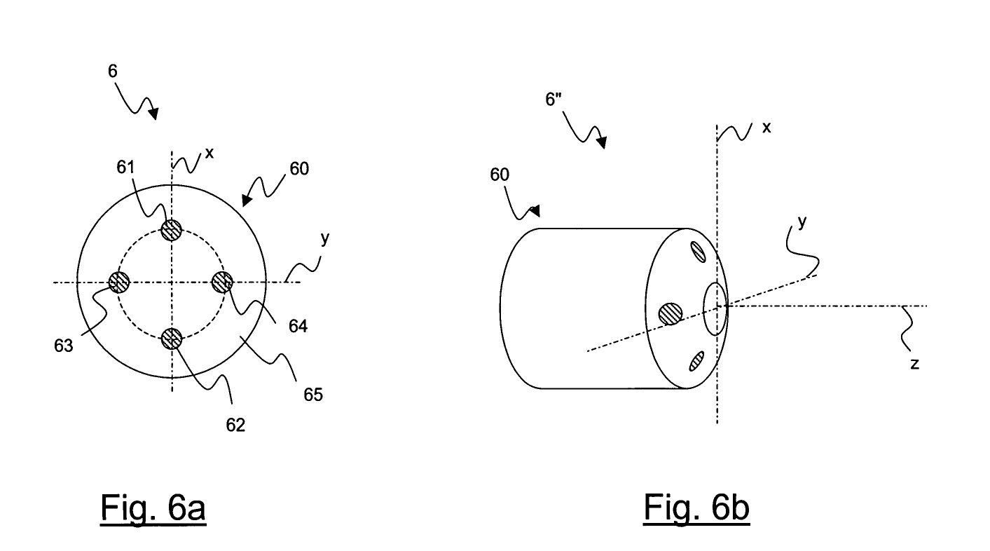

FIGS. 6a and 6b show a probe of the optical device according to a third embodiment of the present invention, in cross section and in perspective, respectively;

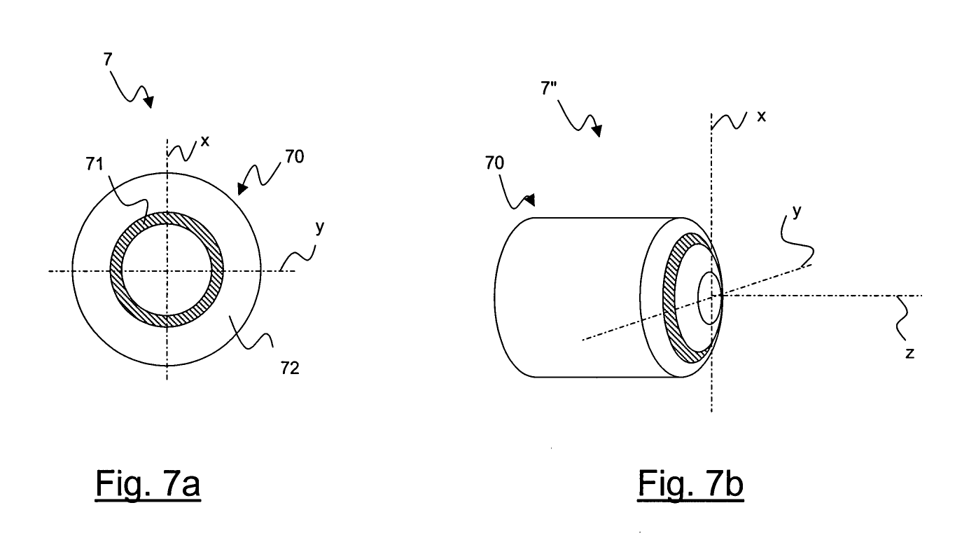

FIGS. 7a and 7b show a probe of the optical device according to a fourth embodiment of the present invention, in cross section and in perspective, respectively; and

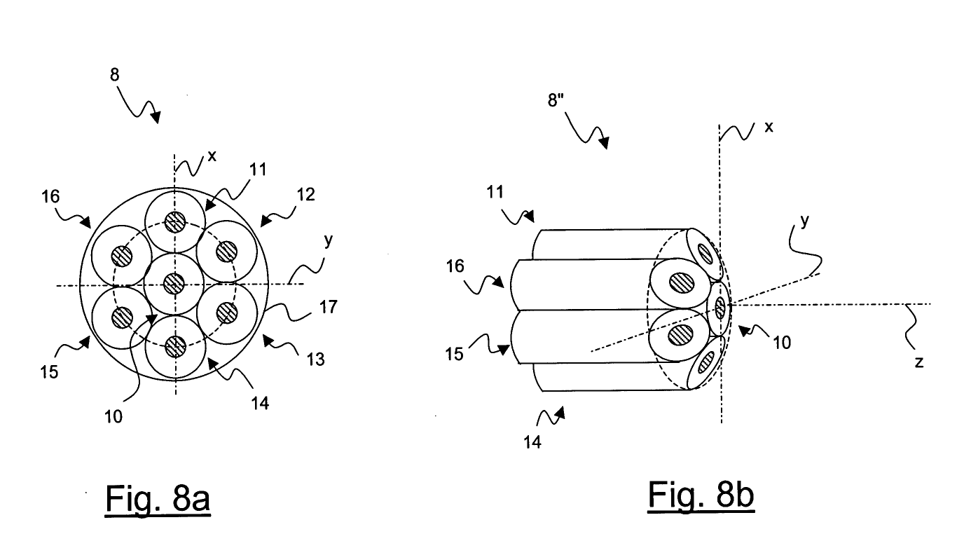

FIGS. 8a and 8b show a probe of the optical device according to a fifth embodiment of the present invention, in cross section and in perspective, respectively.

All the Figures are schematic representations and they are not in scale.

The optical device 1 for trapping a particle according to the present invention comprises a laser source 3 configured to emit a light radiation at a predetermined wavelength. Preferably, the predetermined wavelength is comprised between 500 nm and 2000 nm. The laser source 3 may be a laser source emitting at a constant optical power, or a pulsed laser source. Further, the laser source 3, according to embodiments not shown in the drawings, may comprise a plurality of lasers emitting substantially at the same wavelength and substantially at a same optical power, as it will be described in detail herein after.

The device further comprises a probe 2, in turn comprising at least one optical fiber (not shown in FIG. 1), as it will be explained in further detail herein after. A first end 2′ of the probe is coupled to the laser source 3, so that the optical fiber(s) guide the light radiation emitted by the laser source 3 from the first end 2′ to a second end 2″ of the probe 2. Such a second end 2″ is configured to be immersed in a suspension 4 contained in a container 5. The suspension 4 comprises a fluid and the particle in suspension to be trapped.

FIGS. 2a and 2b show a probe 2 which can be used to implement the device 1 of FIG. 1 according to a first embodiment of the present invention. In particular, FIG. 2a shows a cross section of the probe 2, while FIG. 2b shows a perspective view of portion of the second end 2″ of the probe 2.

The probe 2 comprises a first optical fiber 11 having a first core 111 and a first cladding 112, and a second optical fiber 12 having a second core 121 and a second cladding 122. Preferably, the fibers 11 and 12 have substantially identical optical and geometrical characteristics (such as, for instance, refractive index profile, core and cladding diameters, attenuation, etc.).

Further, preferably, at least at the second end 2″, the fibers 11 and 12 have axis parallel to a first direction indicated as z in FIG. 2b. Further, preferably, at least at the second end 2″, the axis of the first fiber 11 and the second fiber 12 lie on a same plane identified by the direction z and a second direction x. The second direction x is perpendicular to the direction z and is visible in FIGS. 2a and 2b. Therefore, at least at the end 2″, the optical guiding structure of the probe 2 has a rotational symmetry about the direction z (the rotation angle is 180°).

In the FIGS. 2a and 2b, also a third direction y is shown, which is perpendicular to the direction z and the direction x.

As shown in FIG. 2b, the end 2″ of the probe 2 has a tapered shape with a rotational symmetry about the direction z, as it will be described in further detail herein after by referring to FIG. 3a.

FIG. 3a shows the trace of two planes p1, p2 according to which the end 2″ of the probe 2 is tapered. The planes p1 and p2 are both perpendicular to the plane identified by the directions x and z. Further, the plane p1 cutting the first fiber 11 forms an angle θ1 with the plane identified by the directions x and y, while the plane p2 cutting the second fiber 12 forms an angle θ2 with the plane identified by the directions x and y.

According to embodiments of the present invention, the surfaces of the fibers 11 and 12 cut according to the planes p1 and p2 may be metalized, for reasons which will be explained herein after.

In the following description and in the claims, the angles formed by the planes according to which the end of the probe is tapered and by the plane identified by the directions x and y (such as for instance the angles θ1, θ2) will be termed “tapering angles”.

Preferably, for preserving rotational symmetry of the end 2″ of the probe 2 about the direction z, the tapering angles θ1 and θ2 substantially have a same value. Further, preferably, the value of the tapering angles θ1 and θ2 is chosen according to criteria which will be explained in further detail herein after.

By referring always to FIG. 3a, the operation of the probe 2 will be now explained in detail.

When the laser source (not shown in FIG. 3a) emits a light radiation, the light radiation is coupled to the first end of the probe 2, so that a first radiation component is guided by the first fiber 11, and a second radiation component is guided by the second fiber 12. Preferably, the first and second radiation components have substantially the same optical power. In this way, the intensity profile of the radiation guided in the probe 2 also has a rotational symmetry about the axis z.

It is assumed that, at least at the end 2″ of the probe 2, the radiation propagates in the fibers 11 and 12 only according to the respective fundamental modes. Since, as it is known, each of these fundamental modes (symbolically shown in FIG. 3a by means of the two curves M1, M2) has a gaussian intensity distribution, wherein the gaussian maximum substantially corresponds to the axis of the respective optical fiber 11, 12, the greatest part of the optical power associated to the first and second radiation component is concentrated in the respective core 111, 121, as shown in FIG. 3a.

FIG. 3a shows, by means of two arrows r1 and r2, the optical paths followed by the first and second radiation components, respectively.

In particular, in a first length r11, the first radiation component travels in the core 111 of the first fiber 11 until a point A1, wherein the fiber 11 is obliquely cut according to the plane p1. In particular, at the point A1, the first radiation component is at least partially reflected. The tapering angle θ1 is preferably chosen so that the reflected portion of the first radiation component does not intersect the axis z before exiting the probe 2. Accordingly, in the embodiment shown in FIG. 3a, the tapering angle θ1 is higher than 45°. In particular, if the chosen tapering angle θ1 is higher than 45° and lower than the critical angle of the interface between the fiber 11 and the fluid (not shown in FIG. 3a) wherein the particle to be trapped is immersed, at point A1 the first radiation component undergoes both reflection and refraction (for simplicity, refraction is not shown). Otherwise, if the chosen tapering angle θ1 is higher than or equal to the critical angle of the interface between the fiber 11 and the fluid (not shown in FIG. 3a) wherein the particle to be trapped is immersed, at point A1 the first radiation component impinges on the plane p1 with an angle higher than the critical angle, and therefore it undergoes total reflection. In the embodiments wherein the surfaces of the fibers 11 and 12 cut according to the planes p1 and p2 are metalized, the first radiation component undergoes total reflection in A1 for any value of the tapering angle θ1. Also in this latter case, the tapering angle is anyway chosen higher than 45°, so that the reflected portion of the first radiation component does not intersect the axis z before exiting the probe 2.

Then, in a second length r12, the first radiation component propagates until a point B1 of interface between the first optical fiber 11 and the fluid (not shown in FIG. 3a) wherein the particle to be trapped is immersed. At point B1, the first radiation component undergoes refraction, and therefore it is output by the probe at a convergence angle φ1 relative to the direction z, as indicated by the third length r13. The convergence angle φ1 depends on the tapering angle θ1 according to the following equation:

$$ϕ1 = arcsin [ \frac{nF}{nM} sin ( 180 - 2 θ 1 ) ] , \qquad [ 1 ]$$

wherein nF is the average refractive index of the fiber 11 and nM is the refractive index of the fluid wherein the particle to be trapped is immersed. The angles are expressed in degrees.

FIG. 4 shows a graph of the convergence angle φ1 versus the tapering angle θ1, under the assumption that nF is equal to about 1.45 (average refractive index of a silica based optical fiber) and nM is equal to about 1.33 (refractive index of water), and that the surfaces of the fibers 11 and 12 cut according to the planes p1 and p2 are not metalized. In the graph of FIG. 4, three ranges a, b, c of values of the tapering angle θ1 are shown.

In the range a, i.e. angles θ1 comprised between 45° and an angle θlim′, the first radiation component undergoes reflection at A1, but when it reaches B1 it undergoes total reflection, and therefore it is not output by the probe 2. The angle θlim′ depends on the refractive indexes nF and nM according to the equation:

$$θ {lim}^{′} = \frac{180 - arcsin ( nM \text{/} nF )}{2} \qquad [ 2 ]$$

With the above considered values of refractive indexes, the critical angle θlim′ has a value of about 56°. However, according to embodiments of the present invention not shown in the drawings, the radiation may exit the probe 2 also with tapering angles θ1 comprised between 45° and θlim′, if the interface surface comprising point B1 (which in FIG. 3a is substantially perpendicular to the axis z) is inclined relative to the axis z by an angle different from 90° and suitable to prevent total reflection at point B1. The computation of such an angle is obvious to a skilled person, and therefore a detailed description is omitted.

In the second range b, the angle θ1 has values comprised between the angle θlim′ and the critical angle θlim of the interface between the fiber 11 and the fluid wherein the particle to be trapped is immersed. Such a critical angle θlim is given by the following equation:

$$θ lim = arcsin ( \frac{nM}{n F} ) . \qquad [ 3 ]$$

Then, with the above considered values of the refractive indexes nM and nF, the critical angle θlim has a value of about 66.5°. In the range b, a part of the first radiation component is reflected at point A1, and when it reaches point B1 it undergoes refraction and it exits the probe 2 with the convergence angle φ1 shown in the range b of the graph of FIG. 4.

In the range c, i.e. tapering angles θ1 higher than θlim, the first radiation component undergoes total reflection in A1 and refraction in B1, and then it is output at the convergence angle φ1 shown in range c of the graph of FIG. 4. By increasing the tapering angle θ1, the convergence angle φ1 substantially linearly decreases from a maximum value (focusing substantially close to the probe 2) to a minimum value 0° (focusing at infinity).

Regarding the second radiation component guided by the second fiber 12, since both the probe structure and the intensity profile of the guided radiation have rotational symmetry about the direction z, the same considerations relating to the first radiation component apply. Such considerations will be briefly summarized herein after.

In a first length r21, the second radiation component travels in the core 121 of the second fiber 12 until point A2 wherein the fiber 12 is obliquely cut according to the plane p2. At point A2, the second radiation component is at least partially reflected.

Then, in a second length r22, the second radiation component propagates until point B2 of interface between the second optical fiber 12 and the fluid (not shown) wherein the particle to be trapped is immersed. At point B2, the second radiation component undergoes refraction, and therefore it is output by the probe with a convergence angle φ2 relative to the direction z, as shown by the third length r23. The convergence angle φ2 depends on the angle θ2 according to above equation [1], therein the index “1” is replaced by the index “2”.

Therefore, the two convergence angles φ1 and φ2 of the two radiation components are substantially identical. This means that the two radiation components are focused at a point F, which is placed on the axis z at a convergence distance df from the end 2″ of the probe 2. In other words, the probe 2 acts as a optical element with converging power, configured to focus the radiation emitted by the laser source in the point F. Accordingly, when the end 2″ of the probe 2 is immersed in a fluid close to the particle, the radiation output by the probe 2 draws the particle towards the stable equilibrium point F1, place on the axis z at a distance df1 from the probe end, and it substantially traps the particle in the stable equilibrium point F1. The distance df and the distance df1 increase by decreasing the convergence angles φ1 and φ2, i.e. by increasing the tapering angles θ1 and θ2. Further, the distance df and the distance df1 substantially linearly increase by increasing the distance along the direction x between the axis z of the probe 2 and the positions of the cores 111 and 121 of the two fibers 11, 12.

The optical device of the present invention, comprising the probe 2, has several advantages relative to the above known probes.

First of all, the converging effect of the probe 2 is obtained not through refraction as in the known devices, but through the combination of two factors:
the radiation in the probe has intensity profile with rotational symmetry about the axis z of the probe, wherein the intensity maxima have non-zero distance from the axis z; and
focusing of the radiation guided in the probe is implemented through (either partial or total) reflection at the interface between the fibers comprised in the probe and the fluid wherein the particle is immersed.

This advantageously allows to obtain convergence angles higher than the angles obtained with known probes, while having at the same time higher convergence distances than distances obtained with known probes.

For instance, while the known probes (in particular, the fiber probes based on refraction) allow to obtain maximum numerical apertures of about 0.5, the probe of the device according to an embodiment of the present invention advantageously allows to obtain a numerical aperture of about 1.05, i.e. at least two times, when nF=1.45 and nM=1.33. Accordingly, this allows to obtain more stable optical traps. On the other hand, while known probes (in particular, microscope-based probes) allow to obtain convergence distances of few microns, the above described probe allows to obtain convergence distances between 10 μm and 200 μm.

Further, advantageously, the numerical aperture of the probe may be further increased by metalizing the inclined surface of the interface between the probe fibers and the fluid. This advantageously allows to further reduce the angles θ1 and θ2, thereby having convergence angles more close to 90°, with an increase of the optical trap stability.

Further, advantageously, the present device allows to have a scattering force substantially negligible in comparison to the maximum gradient force, at least at the stable convergence point F1. Indeed, while in the known devices the major convergent effect is applied to lateral zones of the radiation propagation mode in the fiber, in the probe of the present device the maximum convergent effect is in the zones wherein the greatest part of the optical power is concentrated. This advantageously allows to minimize the portion of the radiation exiting the probe which is associated to collimated rays, and therefore to minimize the scattering force impact.

FIG. 3b show a longitudinal sectional view of a variant 2″-b of the probe shown in FIGS. 2a, 2b and 3a. Such a variant 2″-b comprises two optical fibers 11, 12 preferably having substantially identical optical and geometrical characteristics. Further, preferably, at least at the second end 2″-b, the fibers 11 and 12 have axis parallel to the direction z and the axis of the fibers 11 and 12 lie on the plane identified by the directions x and z. Accordingly, also in this variant, at least at the end 2″-b, the optical guiding structure of the probe has a rotational symmetry about the longitudinal axis z (the rotation angle is 180°). However, while at the end 2″ shown in FIG. 3a the entire transversal section of the fibers 11 and 12 is cut according to the planes p1 and p2, in the end 2″-b of FIG. 3b the planes p1 and p2 substantially cut only the cores 111, 112, respectively, of the first and second fibers 11, 12, i.e. only the maximum radiation intensity regions. Also in this variant, preferably, for preserving rotational symmetry of the end 2″-b about the direction z, the tapering angles θ1 and θ2 have substantially a same value. Further, preferably, the value of the tapering angles θ1 and θ2 is higher than 45°. The operation of the probe with end 2″-b is identical to the operation of the probe with end 2″. Indeed, also at the end 2″-b the radiation is reflected at points A1 and A2, corresponding to the zones wherein the greatest part of the radiation optical power is concentrated.

This variant advantageously allows to reduce the time for manufacturing the probe, since fiber cutting has to be performed only at the cores, and therefore on a smaller surface.

FIGS. 5a and 5b show a probe 5 which can be used to implement the device 1 of FIG. 1, according to a second embodiment of the present invention. In particular, FIG. 5a shows a cross section of the probe 5, whereas FIG. 5b shows a portion of the second end 5″ of the probe 5 in perspective.

The probe 2 comprises four optical fibers 11, 12, 13, 14 and an elongated central element 10. The elongated central element 10 may be for instance a reinforcing element of dielectric material, or an optical fiber, as it will be described in detail herein after. Preferably, the optical fibers 11, 12, 13, 14 have substantially identical optical and geometrical characteristics (such as, for instance, refractive index profile, core and cladding diameters, attenuation, cut-off wavelength, etc.).

Further, preferably, at least at the second end 5″, the central element 10 and the fibers 11, 12, 13 and 14 have axis parallel to the direction z in FIG. 2b. Further, preferably, at least at the second end 5″, the axis of the central element 10 and of the fibers 11 and 12 lie on a same plane identified by the direction z and the direction x. Further, preferably, at least at the second end 5″, the axis of the central element 10 and of the fibers 13 and 14 lie on a same plane identified by the direction z and by a third direction y. The third direction y is perpendicular to the directions x and z and it can be seen in FIGS. 5a and 5b. Therefore, at least at the end 5″, the guiding structure of the probe 5 has a rotational symmetry about the direction z (the rotation angle is equal to 90°).

As shown in FIG. 5b, the end 5″ of the probe 5 has a tapered shape with rotational symmetry about the direction z.

In particular, the fibers 11, 12 are obliquely cut according to planes which are perpendicular to the plane identified by the directions x and z, and which form with the plane identified by the directions x and y respective tapering angles. Similarly, the fibers 13, 14 are obliquely cut according to planes which are perpendicular to the plane identified by the directions y and z, and which form with the plane identified by the directions x and y respective tapering angles.

Preferably, for preserving rotational symmetry of the end 5″ of the probe 5 about the direction z, the tapering angles of the fibers 11, 12, 13 and 14 have a same value, which is termed θ. The angle θ is chosen according to criteria analogous to the criteria described by referring to FIG. 3a.

The operation of the probe 5 is substantially the same of the above described probe 2. Therefore, it will be only briefly summarized herein after.

When the laser source emits a light radiation, the light radiation is coupled to the first end of the probe 5, so that each optical fiber 11, 12, 13, 14 guides a respective radiation component. Preferably, the four radiation components have substantially the same optical powers. In this way, the intensity profile of the radiation guided in the probe 5 also has a rotational symmetry about the direction z.

Also in this case, it is assumed that, at least at the end 5″ of the probe 5, the radiation propagates in the fibers 11, 12, 13, 14 only according to respective fundamental modes, so that the greatest part of the optical power associated to each radiation component is concentrated in the respective core.

When each radiation component reaches the point in which the respective fiber (or fiber core) is obliquely cut (i.e. at the interface between fiber and fluid), it undergoes reflection.

Then, the reflected part of each radiation component propagates within the probe until it undergoes refraction at the interface between the central element 10 and the fluid, and then it is output by the probe with a convergence angle φ relative to the direction z. The convergence angle φ has substantially a same value for all the four radiation components. The convergence angle φ depends of the tapering angle θ according to the above equation [1].

Therefore, due to the structure rotational symmetry, the radiation components are focused at a convergence point, which is placed on the axis z at a distance df from the end 5″ of the probe 5. Therefore, when the end 5″ of the probe 5 is immersed in a fluid close to a particle, the radiation output by the probe 5 draws the particle towards a stable equilibrium point placed on the axis z, and substantially traps the particle in the equilibrium point. Also in this case, the distance between the equilibrium point and the end of the probe increases by decreasing the convergence angle φ i.e. by increasing the tapering angle θ. Further, such a distance increases by increasing the distance of the fibers 11, 12, 13, 14 from the probe axis z.

According to other embodiments, the probe may be implemented by using a single fiber having a least two convex-shaped (e.g. circle) cores arranged according to a rotational symmetry about the fiber axis.

For instance, FIGS. 6a and 6b show a third embodiment of a probe comprising a fiber with four circular cores. In particular, FIG. 6a shows a cross section of the probe 6, while FIG. 6b shows a portion of the second end 6″ of the probe 6 in perspective.

The probe 6 comprises an optical fiber 60, having a cladding 65 and four circular cores 61, 62, 63, 64 arranged according to a rotational symmetry about the fiber axis z. Advantageously, the cores 61, 62, 63, 64 have substantially identical optical and geometrical characteristics (e.g. refractive index profile, diameter, etc.).

As shown in FIG. 6b, at the end 6″, the optical fiber 60 is tapered, so that it has a conical frustum shape with axis substantially corresponding to the direction z. In this way, the cores 61, 62, 63 and 64 are cut according to respective planes forming with the plane identified by the directions x and y a same angle, which in the following will be termed θ. Alternatively, advantageously, the end 6″ has a shape of a frustum of straight pyramid with squared base.

The operation of the probe 6 is substantially the same as the above described probe 2. Accordingly, it will not be repeated, and for a more detailed description reference can be made to the description of FIG. 3a.

According to other embodiments, the probe may be implemented by using a single optical fiber having a substantially rotational symmetry about the fiber axis z.

For instance, FIGS. 7a and 7b show a fourth embodiment of a probe comprising a fiber with a annular core. In particular, FIG. 7a shows a cross section of the probe 7, while FIG. 7b shows a portion of the second end 7″ of the probe 7 in perspective.

The probe 7 comprises an optical fiber 70, having a cladding 72 and an annular core 71 having a rotational symmetry about the fiber axis z. Advantageously, the core optical and geometrical characteristics (such as refractive index profile, inner and outer diameter, etc.) are substantially constant along the whole perimeter of the core 71.

According to the present invention, and as shown in FIG. 7b, at the end 7″, the optical fiber 70 is tapered, so that it has a frustum conic shape with axis substantially corresponding to the direction z. In this way, the core 71 in each point of its perimeter is cut according to a respective plane forming a tapering angle θ with the plane identified by the directions x and y. Such a tapering angle θ has a substantially constant value along the whole perimeter of the core 71. Alternatively, advantageously, the end 7″ has a shape of a frustum of straight pyramid having a base in the form of a regular polygon.

The operation of the probe 7 is substantially the same of the above described probe 2. Accordingly, it will not be repeated, and for a more description reference can be made to the description of FIG. 3a.

FIGS. 8a and 8b show a fifth embodiment of a probe comprising seven optical fibers. In particular, FIG. 8a shows a cross section of the probe 8, while FIG. 8b shows a portion of the second end 8″ of the probe 8 in perspective.

The probe 8 comprises seven optical fibers 10, 11, 12, 13, 14, 15, 16. A first optical fiber 10 is placed with axis substantially corresponding to the probe axis z. The six remaining optical fibers 11, 12, 13, 14, 15, 16 are placed with axis parallel to the axis z, and they are placed at the vertexes of a regular hexagon lying in the xy plane. In this way, a core distribution with rotational symmetry about the axis z of the probe 8 is obtained.

Preferably, the optical fibers 10, 11, 12, 13, 14, 15, 16 are reduced diameter cladding fibers, so that the diameter of the probe 8 is reduced as much as possible. Examples of such fibers are the optical fibers RC HI 1060 Specialty Fibers, manufactured by Corning, N.Y. (USA). Such fibers typically have a cladding outer diameter of about 80 μm, a maximum attenuation at 1060 nm of about 1.5 dB/km, a cut-off wavelength of about 920 nm and a mode field diameter at 1060 nm of about 6.2 μm.

The central fiber 10 may be of the same type as the surrounding fibers, or it may be different.

The fibers are preferably inserted into a capillary 17 made of plastic material. For instance, the Applicant has performed some positive tests by using a capillary of the type TSP 250350 manufactured by Polymicro Technologies LLC, Phoenix, Ariz. (USA). Preferably, the free space between the optical fibers and the inner wall of the capillary may be filled with a filler blocking the fibers within the capillary. For instance, the Applicant has performed some positive tests by using the epoxy resin EpoFix produced by Struers, Copenaghen (Denmark).

As shown in FIG. 8b, the end 8″ of the probe 8 has a tapered shape with rotational symmetry about the direction z. In particular, each fiber 11, 12, 13, 14, 15, 16 (or each fiber core) is obliquely cut according to a respective plane forming a tapering angle θ with the plane identified by the directions x and y. Preferably, for preserving rotational symmetry of the end 8″ of the probe 8 about the direction z, all the tapering angles θ have a same value.

The operation of the probe 8 is substantially the same of the above described probe 2. Accordingly, it will only briefly summarized herein after.

When the laser source (not shown in FIGS. 8a, 8b) emits a light radiation, the light radiation is coupled to the first end of the probe 8, so that each optical fiber 11, 12, 13, 14, 15, 16 guides a respective radiation component. Preferably, the six radiation components have a substantially identical optical power. In this way, the intensity profile of the radiation guided within the probe 8 also has a rotational symmetry about the axis z.

Also in this case, it is assumed that, at least at the end 8″ of the probe 8, in the fibers 11, 12, 13, 14, 15, 16 the radiation propagates substantially according the respective fundamental modes only, so that the greatest part of the optical power associated to each radiation component is concentrated in the respective core.

When each radiation component reaches the point wherein the respective fiber (or at least the zone wherein the radiation has maximum intensity) is obliquely cut (i.e. at the interface between fiber and fluid), it undergoes reflection.

Then, each radiation component propagates within the probe until, at the interface between each fiber and the fluid, it undergoes refraction, and then it is output by the probe with a convergence angle φ relative to the direction z. The convergence angle φ has substantially a same value for all the six radiation components. The convergence angle φ depends on the tapering angle θ according to the above equation [1].

Then, due to the rotational symmetry of the structure, the radiation components are focused at a convergence point placed on the axis z at a given distance from the end 8″ of the probe 8. Therefore, when the end 8″ of the probe 8 is immersed in a fluid close to a particle, the radiation emitted by the probe 8 draws the particle towards an equilibrium point which is also placed on the axis z, and substantially traps the particle in the equilibrium point. Also in this case, the distance df increases by decreasing the convergence angle φ, i.e. by increasing the tapering angle θ. Further, the distance df increases by increasing the distance of the fibers 11, 12, 13, 14, 15, 16 from the probe axis z.

The central fiber 10 may be used for different purposes. For instance, such a fiber may emit light at a wavelength different from the laser source supplying the surrounding fibers. Such a wavelength may be chosen in order to perform an analysis (e.g., a spectroscopy) of the particle.

Therefore, the present invention provides an optical device for trapping a particle, typically a microscopic particle, which advantageously allows to create stable traps in any point of the fluid wherein the particle is immersed, at a distance of some tens of microns away from the end of the probe. In this way, the particle may be easily observed and analysed. The device of the invention is also particularly, compact and cheap to fabricate.

1. An optical device for trapping a particle immersed in a fluid, the device comprising a light source and a probe having a first end, a second end and a longitudinal axis, the probe being configured to receive a radiation from the light source at the first end and to output the radiation through the second end, wherein the optical device being characterized in that:
at the second end, the radiation has an optical intensity distribution with intensity maximum placed at a non-zero distance from the longitudinal axis of the probe and with rotational symmetry about the longitudinal axis; and
said second end is configured so that at said intensity maximum the radiation is reflected at the interface between said second end and said fluid, and the reflected radiation is output from the second end so that it converges in a convergence point, thus creating a stable equilibrium point wherein the particle is trapped.

2. The device according to claim 1, wherein, at least at said intensity maximum, said second end has a tapered shape having rotational symmetry about the longitudinal axis and having a given tapering angle.

3. The device according to claim 2, wherein said tapering angle is equal to or higher than a critical angle of the interface between said second end and said fluid.

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. The device according to claim 3, wherein the probe further comprises an optical fiber having at least two cores configured to have identical optical and geometrical characteristics, said at least two cores, at the second end of the probe, being arranged parallel to the longitudinal axis of the probe with rotational symmetry about the longitudinal axis of the probe, and where said tapered shape is at least one of a conical frustum and a straight pyramid having a regular polygon as a base.

19. The device according to claim 3, wherein the probe further comprises an optical fiber having an annular core having optical and geometrical characteristics substantially constant along a perimeter of said annular core, and where said tapered shape is at least one of a conical frustum and a straight pyramid having a regular polygon as a base.

20. The device according to claim 3, wherein the probe further comprises at least two optical fibers, each comprising a respective core, said at least two fibers being configured to have identical optical and geometrical characteristics, said at least two fibers, at the second end of the probe, being arranged parallel to the longitudinal axis with a substantially rotational symmetry about said longitudinal axis.

21. The device according to claim 20, wherein each of said at least two optical fibers, at the second end of the probe, is cut at least in the region of its core according to a plane forming an angle with a plane perpendicular to the longitudinal axis of the probe, said angle being equal to said tapering angle.

22. The device according claim 21, wherein the probe further comprises a central element having longitudinal axis substantially corresponding to said longitudinal axis of the probe where the central element comprises at least one of a:
a. reinforcing element comprising dielectric material; and
b. an optical fiber.

23. The device according to claim 2, wherein said tapering angle is equal to or higher than 45°.

24. The device according to claim 23, wherein the probe further comprises an optical fiber having at least two cores configured to have identical optical and geometrical characteristics, said at least two cores, at the second end of the probe, being arranged parallel to the longitudinal axis of the probe with rotational symmetry about the longitudinal axis of the probe, and where said tapered shape is at least one of a conical frustum and a straight pyramid having a regular polygon as a base.

25. The device according to claim 23, wherein the probe further comprises an optical fiber having an annular core having optical and geometrical characteristics substantially constant along a perimeter of said annular core, and where said tapered shape is at least one of a conical frustum and a straight pyramid having a regular polygon as a base.

26. The device according to claim 23, wherein the probe further comprises at least two optical fibers, each comprising a respective core, said at least two fibers being configured to have identical optical and geometrical characteristics, said at least two fibers, at the second end of the probe, being arranged parallel to the longitudinal axis with a substantially rotational symmetry about said longitudinal axis.

27. The device according to claim 26, wherein each of said at least two optical fibers, at the second end of the probe, is cut at least in the region of its core according to a plane forming an angle with a plane perpendicular to the longitudinal axis of the probe, said angle being equal to said tapering angle.

28. The device according claim 27, wherein the probe further comprises a central element having longitudinal axis substantially corresponding to said longitudinal axis of the probe where the central element comprises at least one of a:
a. reinforcing element comprising dielectric material; and
b. an optical fiber.

29. A method for trapping a particle immersed in a fluid, comprising:
emitting a radiation through a laser source;
guiding the radiation from a first end to a second end of a probe; and
outputting said radiation through said second end, wherein
at the second end of the probe, the radiation has an optical intensity distribution with intensity maximum placed at a non-zero distance from a longitudinal axis of the probe and having substantially rotational symmetry about the longitudinal axis of the probe; and
at said second end and at said intensity maximum, the radiation is reflected at an interface between said second end and said fluid, and it is output from said second end so that it converges in a convergence point, thus creating a stable equilibrium point wherein the particle is trapped.

30. The method according to claim 29, wherein said optical intensity distribution comprises at least two intensity maxima placed at a non-zero distance from said longitudinal axis of the probe and arranged according to a rotational symmetry about the longitudinal axis of the probe.

31. The method according to claim 29, wherein said optical intensity distribution comprises at least an annular intensity maximum.

32. The method according to claim 29, wherein the radiation is reflected at the interface between said second end and said fluid in such a manner to induce total reflection of said radiation.

33. The method according to claim 32, wherein said optical intensity distribution comprises at least two intensity maxima placed at a non-zero distance from said longitudinal axis of the probe and arranged according to a rotational symmetry about the longitudinal axis of the probe.

34. The method according to claim 32, wherein said optical intensity distribution comprises at least an annular intensity maximum.
